(19) United States
(12) Patent Application Publication
(10) Pub. No.: US 2014/0214617 A1
(43) Pub. Date: Jul. 31, 2014

(54) PRICING INTELLIGENCE FOR NON-IDENTICALLY IDENTIFIED PRODUCTS

(71) Applicant: 360PI CORPORATION, Ottawa (CA)

(72) Inventors: Dominic Pierre PLOUFFE, Ottawa (CA); James Harold REED, Ottawa (CA); Matthew Steven KITCHING, Ottawa (CA)

(73) Assignee: 360PI CORPORATION, Ottawa (CA)

(21) Appl. No.: 13/752,975

(22) Filed: Jan. 29, 2013

(51) Int. Cl. G06Q 30/02

(52) U.S. Cl. CPC G06Q 30/0283; G06Q 30/0623
USPC 705/26.61

(57) ABSTRACT

A computer system-implemented method comprises using a process in execution on a processor of a computer system to access, from a database and/or from product information pages on a first retailer's e-commerce site, product description information and pricing information for a product sold by the first retailer. Using a robot module, product description information and pricing information for a non-identically identified product that is offered for sale by a second retailer is accessed via an electronic communication network. Product matching rules with parameters that are adjustable by product are implemented and accessed to automatically determine whether or not an exact feature match exists between the product and the non-identically identified product. Upon determining an exact feature match, a data output linking the product and the non-identically identified product is generated automatically, the data output for being accessed by a price comparison process.

### FIELD OF THE INVENTION

The invention relates generally to pricing intelligence, and more particularly to an automated method and system for comparing pricing information for non-identically identified products.

### BACKGROUND OF THE INVENTION

A retailer, if they are to attract customers, should provide service, convenience, selection and/or pricing that is superior to that being offered by their competitors. Of course, pricing often winds up being the determining factor when a potential customer is deciding where to make his or her purchase, and this is especially true in the case of on-line retail sales since service, convenience, and selection tend to be more-or-less the same from one on-line retailer to another. That said, retailers who sell their products via “brick-and-mortar” stores must also balance supplying products at a competitive price against the overhead costs associated with maintaining such stores. Pricing intelligence has therefore become an important tool in the retail environment, and is being used increasingly by retailers to improve their competitiveness while at the same time maximizing profits. In simple terms, pricing intelligence entails a detailed analysis of pricing information using modern data mining techniques, and is differentiated from other pricing methods by the extent and accuracy of the analysis.

In order to successfully implement a pricing intelligence method, a subject retailer must have access to reliable and current pricing information, which is for instance obtained from a competitor's e-commerce site and/or from another electronically accessible database. Typically, raw pricing information is obtained in an automated fashion using web-crawlers or web-scrapers. Unfortunately, the acquisition of meaningful pricing information is complicated by a number of factors, such as the need to account for shipping costs in the overall price of a product, the need to purchase multiple items in order to qualify for an advertised discount, or the need to account for the value of “free gifts” that are included with the purchase of a product, etc. Further, some e-commerce sites require products to be placed into a shopping cart before pricing information is provided, or a site may impose limits on the number of requests that can be made. As such, web-crawlers or web-scrapers that are used to obtain pricing information from different e-commerce sites should be able to simulate certain human activities and/or be able to extract data that is presented in different formats. Additionally, the pricing information should be updated or refreshed from time to time in order to account for price changes, or to account for the introduction of new products or the discontinuation of existing products, etc.

Even after the pricing information has been obtained from a competitor's e-commerce site, comparing this pricing information to the subject retailer's information is complicated by the fact that most e-commerce sites do not put reliable, vendor-independent identifiers on their product pages. For instance, it is relatively uncommon for Universal Product Codes (UPCs) to be included on product pages. Instead, retailers more commonly include stock keeping units (SKUs) or manufacturer model numbers along with a description of the product. Since UPCs are for external or universal use, it would be a relatively simple matter to compare the prices that are advertised by different vendors for products that have the same UPC. On the other hand, SKUs are assigned to a product by each different retailer for stock-keeping purposes and internal operations, and are not particularly useful for inter-vendor product matching or for price comparison applications.

Comparing the pricing information that is obtained from different vendors' e-commerce sites is further complicated due to the common practice of selling identical products under different house brands or private labels. In this scenario, one retailer offers a product for sale under a first brand name and another retailer offers a product with identical features for sale under a second brand name. Aside from different branding and possibly minor cosmetic or styling differences, the products are identical. In a closely related scenario, different retailers may offer different products that have very similar feature sets, e.g. “exclusive models” that are only available from a specific retailer. For instance, a manufacturer provides different modifications of a particular product to different retailers so that each retailer can offer a different exclusive model, and thereby avoid the need to price-match when a similar but non-identical exclusive model is advertised at a lower price. Different exclusive models commonly have one, or sometimes a few, features either more or less than a “standard” model that is produced by the same manufacturer. By way of a specific and non-limiting example, an exclusive model of a 50-inch plasma HDTV that is available from a particular retailer has one additional HDMI input compared to the “standard” HDTV model of the same brand that is available from another retailer. In this case, the manufacturer is likely to use different model numbers for the standard HDTV model and for the exclusive HDTV model, and similarly each retailer is likely to use a different SKU.

Of course, matching engines are known for performing apples-to-apples type matches of products that are found on a competitor's e-commerce site. For instance, artificial intelligence, semantic analysis, data mining, and image recognition technologies can be combined to determine exact product matches even when a unique product identifier, such as a UPC, is not provided on the product page. Such matching engines are also capable of recognizing size and color variants of a product. That said, the matched products are identical models with identical features sets and identical brands. As noted above, different retailers often do not offer for sale identical products.

Pricing intelligence results that are based on exact product matches do provide the subject retailer with valuable insight into their marketplace, and will allow the subject retailer to make important pricing decisions. That being said, a price conscious consumer may be willing to consider an alternative product that is not available from the subject retailer. For instance, a consumer who wishes to purchase a 50-inch HDTV may be willing to consider identically featured products under the Sony®, Samsung® and LG® brands. According to this scenario, implementation of a prior art pricing intelligence method based on an apple-to-apple type product match may result in the subject retailer adjusting the price of a Sony® 50-inch LED-LCD HDTV in order to be price competitive with the identical Sony® 50-inch LED-LCD HDTV that is offered by a competitor. However, if the competitor also offers a Samsung® 50-inch LED-LCD HDTV or a LG® 50-inch LED-LCD HDTV at a lower price than the Sony 50-inch LED-LCD HDTV, then the consumer is likely to choose to purchase either the Samsung® HDTV or the LG® HDTV from the competitor and the subject retailer will lose the sale. Clearly, a pure apple-to-apple type product matching approach does not provide the subject retailer with a full and robust pricing intelligence solution.

Additionally, even if an apple-to-apple type product match is considered to be sufficient for the purposes of the subject retailer, competitors may deliberately foil attempts to employ pricing intelligence methods. For instance, the product page on a competitor's e-commerce site may display the same image for several similar products of the same brand to confound image recognition, may provide a partial or abbreviated feature set description for some products to confound feature-based mapping, or may use non-standard terms to define features also to confound feature-based mapping. Under such circumstances, it is highly unlikely that an automated matching engine will be able to determine even apple-to-apple type product matches with acceptable accuracy, much less determine matches between similar but non-identically identified products.

Retailers are known to employ a small army of trained analysts to perform attribute mapping in a manual fashion. Optionally, an automated filtering process provides a list of likely or possible matches that are to be evaluated by a human analyst. Alternatively, the attribute mapping process is entirely manual and requires one or more human analysts to navigate to each competitor's e-commerce site and review the product description for all of the products that are similar to those offered by the subject retailer. Advantageously, manual attribute mapping provides highly accurate data for use with pricing intelligence methods and is capable of matching similar products, matching house brands or private labels, etc. Further, human analysts are able to determine product matches even when product information is deliberately vague or misleading. Unfortunately, manual attribute mapping is very labor intensive and therefore it is very expensive to perform. Further, it is necessary to periodically update the initial attribute matching in order to account for the introduction of new product models, the discontinuation of old product models, etc. Such updates require considerable additional effort on the part of the human analysts, and are also very expensive to perform. Further, it may be necessary for the subject retailer to spend time and effort reviewing results that are produced by the human analysts and confirm the proposed matches. Such methods based on manual attribute matching are therefore not only very expensive, but also inconvenient.

It would be beneficial to provide a method and system that overcome at least some of the above-mentioned limitations and disadvantages of the prior art.

### SUMMARY OF THE INVENTION

According to an aspect of at least one embodiment of the instant invention, there is provided a computer system-implemented method, comprising: using a process in execution on a processor of a computer system, accessing product description information and pricing information for a product sold by a first retailer; accessing using a robot module, via an electronic communication network, product description information and pricing information for a non-identically identified product that is offered for sale by a second retailer; implementing in a feature analyzer module in execution on the processor of the computer system, product matching rules with parameters that are adjustable by product; accessing implemented product matching rules for the first retailer that cover the product sold by the first retailer, and responsive to the product description information for the product and for the non-identically identified product and said implemented rules, automatically determining whether or not an exact feature match exists between the product and the non-identically identified product; and upon determining an exact feature match, automatically generating a data output linking the product and the non-identically identified product, the data output for being accessed by a price comparison process.

According to an aspect of at least one embodiment of the instant invention, there is provided a computer system-implemented method, comprising: using a process in execution on a processor of a computer system, accessing product description information and pricing information for a product sold by a first retailer; accessing using a robot module, via an electronic communication network, product description information and pricing information for a non-identically identified product that is offered for sale by a second retailer; establishing a set of rules for determining an exact feature match to the product sold by the first retailer; implementing in a feature analyzer module, in execution on the processor of the computer system, the established set of rules; accessing the implemented set of rules, and responsive to the product description information for the product and for the non-identically identified product and said implemented rules, automatically determining whether or not an exact feature match exists between the product and the non-identically identified product; and upon determining an exact feature match, automatically generating a data output linking the product and the non-identically identified product, the data output for being accessed by a price comparison process.

In an embodiment, determining whether or not an exact feature match exists between the product and the non-identically identified product is other than based on a number of search result hits returned for the non-identically identified matching product.

In an embodiment, the non-identically identified product is other than a product that is sponsored for being linked with the product sold by the first retailer.

In an embodiment, determining whether or not an exact feature match exists between the product and the non-identically identified product is performed using an artificial intelligence (AI) process that is in execution on the processor of the computer system.

In an embodiment, the computer system is associated with a price intelligence provider and is remote from the first retailer.

In an embodiment, the step of accessing product description information and pricing information for the product sold by the first retailer comprises retrieving said product description information and pricing information from a database that is maintained for the first retailer.

In an embodiment, the step of accessing product description information and pricing information for the product sold by the first retailer comprises extracting said product description information and pricing information from a product page for the product on an e-commerce site of the first retailer.

In an embodiment, the step of accessing product description information and pricing information for the non-identically identified product that is offered for sale by the second retailer comprises extracting data from a product page for the non-identically identified product on an e-commerce site of the second retailer.

In an embodiment, the step of accessing product description information and pricing information for the non-identically identified product that is offered for sale by the second retailer comprises retrieving data for the non-identically identified product from a database that is maintained for the second retailer.

In an embodiment, comprising building a searchable product index, the searchable product index comprising a plurality of product identifiers, and there being associated with each product identifier an indication of at least one location of product description information and pricing information relating to a product that is identified by said associated product identifier.

In an embodiment, the product description information comprises a set of features associated with the non-identically identified product, and wherein the searchable product index comprises an index linking features to product identifiers such that products are searchable based on the features that are associated therewith.

According to an aspect of at least one embodiment of the instant invention, there is provided a data processing system, comprising: a module executing on a processor and accessing available product description information and pricing information for a product sold by a first retailer; a robot module executing on a processor and accessing, via an electronic communication network, product description information and pricing information for a non-identically identified product that is offered for sale by a second retailer; a module executing on a processor implementing product matching rules with parameters that are adjustable by product; a module executing on a processor accessing the implemented product matching rules for the first retailer that cover the product sold by the first retailer, and responsive to the product description information for the product and for the non-identically identified product and said implemented rules, automatically determining whether or not an exact feature match exists between the product and the non-identically identified product; and a module executing on a processor and responsive to a determination that an exact feature match exists between the product and the non-identically identified product, automatically generating a data output linking the product and the non-identically identified product, the data output for being accessed by a price comparison process.

In an embodiment, the module executing on a processor and accessing said available product description information and pricing information for the product sold by the first retailer is executing on a processor of a computer system associated with a price intelligence provider, the computer system that is associated with the price intelligence provider being remote from the first retailer.

In an embodiment, the first retailer, the second retailer and the price intelligence provider are in communication one with another via the electronic communication network.

In an embodiment, the module executing on a processor and responsive to the data output generating a human-intelligible report including the price of the product compared to the price of the non-identically identified product is executing on a processor of a computer system associated with first retailer.

In an embodiment, each one of the modules is executing on a processor of a computer system associated with a price intelligence provider, the computer system that is associated with the price intelligence provider being remote from the first retailer.

### BRIEF DESCRIPTION OF THE DRAWINGS

The instant invention will now be described by way of example only, and with reference to the attached drawings, wherein similar reference numerals denote similar elements throughout the several views, and in which:

FIG. 1 is a simplified block diagram showing a system according to an embodiment of the instant invention;

FIG. 2 is a simplified diagram of a competitor's product page for a product; and

FIG. 3 is a simplified diagram showing a comparison between the attributes or features of a product that is offered by a subject retailer and the features that are believed to be present in a product that is offered by a competitor.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

In order for two products to be considered “non-identically identified,” each of the two products must have an identical feature set and differ one from the other, at most, only by brand. In this sense, equivalent brand-specific features that are identified using different proprietary terms are not considered to result in non-identical feature sets. For example, identical products that are produced by the same manufacturer, but that are sold by different retailers under different house brands or private labels, are considered to be “non-identically identified” products. Similarly, two products are also considered to be non-identically identified products if both products have identical feature sets and the same brand, but some aspect of the products is described differently by different retailers. This may result from a deliberate attempt to obfuscate the identity of the product in order to foil a competitor's pricing intelligence, or it may result from publishing errors, or other mistakes, or simply due to the usage of different terminology. Further, products that have identical feature sets but are produced by different manufactures under different brands, and that are sold by plural retailers under those brands, are also considered to be “non-identically identified” products. In any of these examples there may be minor cosmetic or styling differences between the “non-identically identified” products, but in terms of the feature sets there is no difference. Further, a consumer having no preference for the brand of a product would consider two “non-identically identified” products to be perfectly interchangeable. That is to say, a match that is determined between “non-identically identified” products is an exact match.

According to an embodiment, a data processing system based on an artificial intelligence (AI) process is used to perform product matching for non-identically identified products. Product description information and pricing information for a product that is sold by a subject retailer is accessed from a memory storage element having stored thereon a database of such information. For instance, the product description information for a particular product includes a manufacturer model number and/or another product identifier code for that product, as well as a list of features or attributes associated with that product. Optionally, a robot module, such as for instance a so-called “web crawler” or “spider,” is used to access the product description information and pricing information for the product that is sold by the subject retailer. For instance, the robot module accesses a plurality of product pages on the subject retailer's e-commerce site and/or retrieves data from the database stored on the memory storage element.

A robot module, such as for instance a so-called “web crawler” or “spider,” is used to access product description information and pricing information for a non-identically identified product that is offered for sale by a competitor. In practice, the robot module accesses a plurality of product pages on the competitor's e-commerce site and/or retrieves data from another electronically accessible database. Some of the accessed product pages and/or some of retrieved data may relate to products that are not matches to any product that is offered by the subject retailer. For example, a competitor offers a television with a feature set that is not identical to the feature set of any television offered by the subject retailer; these products do not match one with the other. Further, some of the accessed product pages and/or some of the retrieved data may relate to products that are identically identified matching products for products offered by the subject retailer. For instance, both the competitor and the subject retailer offer televisions of the same brand and having identical feature sets; these products match exactly and are entirely indistinguishable even when brand is taken into account.

The process of determining if two non-identically identified products are matching products is based on product matching rules, with parameters that are adjustable by product, implemented in a feature analyzer module that is in execution on a processor of the data processing system. This module uses an AI process that is capable of learning how to determine feature-matches between two products that are not identically identified. The AI process is also capable of accounting for missing feature values, and making a probabilistic determination of whether two products are matched. In order for the AI process to learn how to recognize non-identically identified products, the subject retailer may provide initial parameters of the product matching rules for each different product or each different group of products. In addition to the initial values supplied by the subject retailer, robot modules also retrieve additional feature information from the subject retailer's e-commerce site. In an embodiment, a user interface presents the subject retailer with available parameters for each product or group of products and the subject retailer selects and/or enters values for different parameters via the interface. For instance, the subject retailer provides brand-specific terms that are equivalent to the terms that are employed by the manufacturer of a particular product offered by the subject retailer. By way of an example, the subject retailer offers a television with a feature that is referred to by the manufacturer by the proprietary name TruMotion®, and indicates that an equivalent proprietary name used by another brand is MotionFlow®. The AI process performs product matching for the subject retailer based on the initial parameters.

Significantly, the AI process determines whether or not a match exists between the two non-identically identified products based on a comparison of the features that are present in each of the two products. Optionally, the AI process generates a list of possible matches for a product that is offered by the subject retailer, including products that are believed to be non-identically identified matching products. The subject retailer reviews the products that are contained in the list, and confirms matches on a product-by-product basis. The subject retailer may indicate, for instance, that some of the products considered to be non-identically identified matching products are actually not matching products, etc. Based on an analysis of the features that are present in the products that were initially mischaracterized, as well as the features that are present in the products that were initially correctly characterized, the AI system adjusts the parameters of the matching rule. When this process is iterated over time, as new products are introduced or old products are discontinued, the AI process continues to learn the how to identify non-identically identified matching products. Of course, the length of time that is required for the AI process to learn how to determine matches between non-identically identified products depends, partially, on the type of products that are being compared. Products with large feature or attribute sets, such as for instance automobiles or HDTVs, require longer learning periods than products with small feature sets, such as for instance coffee mugs or staplers. Additionally, the quality and consistency of the feedback that is provided by the subject retailer affects the length of time that it takes for the AI process to learn how to determine matches between non-identically identified products.

Upon determining a match between a product that is offered by the subject retailer and a non-identically identified product that is offered by a competitor, a data output linking the product and the non-identically identified matching product is generated. The data output is for being accessed by a price comparison process. A price comparison is performed, based on the data output, and a result of the price comparison is presented in a human-intelligible form.

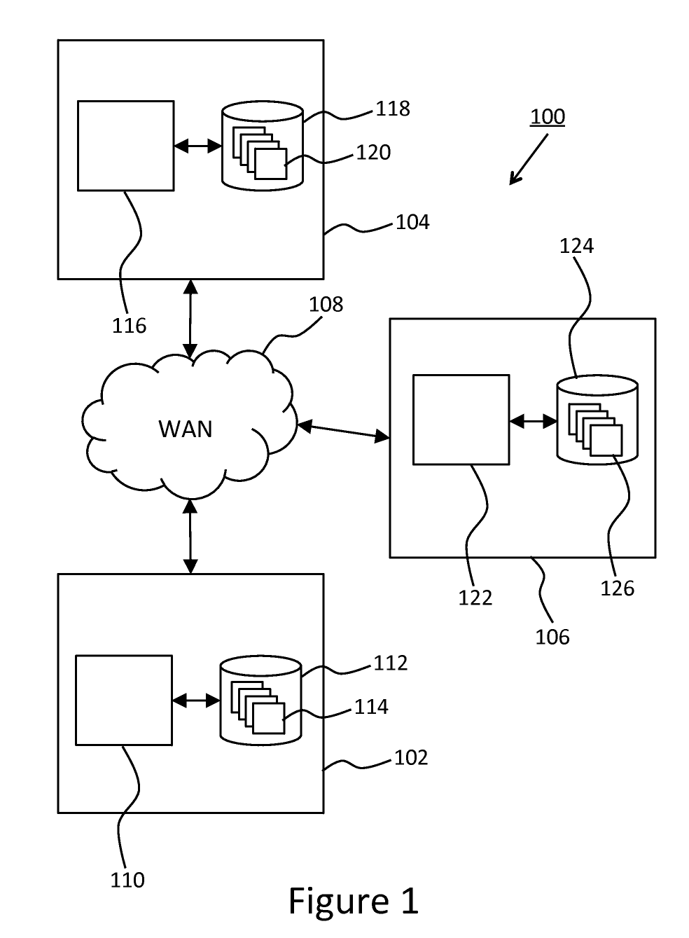

Referring now to FIG. 1, shown is a system 100 according to an embodiment of the instant invention. A subject retailer 102, a competitor 104 and a pricing intelligence provider 106 are in communication one with another via a communications network such as for instance wide area network (WAN) 108. The subject retailer 102 has an e-commerce site 110 in communication with a memory storage device 112 having stored thereon a database including at least inventory data 114 relating to products that are offered by the subject retailer. The inventory data 114 includes pricing information as well as descriptions for each of the products that are offered by the subject retailer. Similarly, the competitor 104 has an e-commerce site 116 in communication with a memory storage device 118 having stored thereon a database including at least inventory data 120 relating to products that are offered by the competitor. The inventory data 120 includes pricing information as well as descriptions for each of the products that are offered. The pricing intelligence provider 106 includes a data processing system 122 for comparing the price of a product sold by the subject retailer 102 to the price a non-identically identified product that is offered for sale by another retailer, such as for instance the competitor 104. The data processing system 122 is in communication with a memory storage device 124 having stored thereon parameter data 126 and other data that is required during use of the data processing system 122.

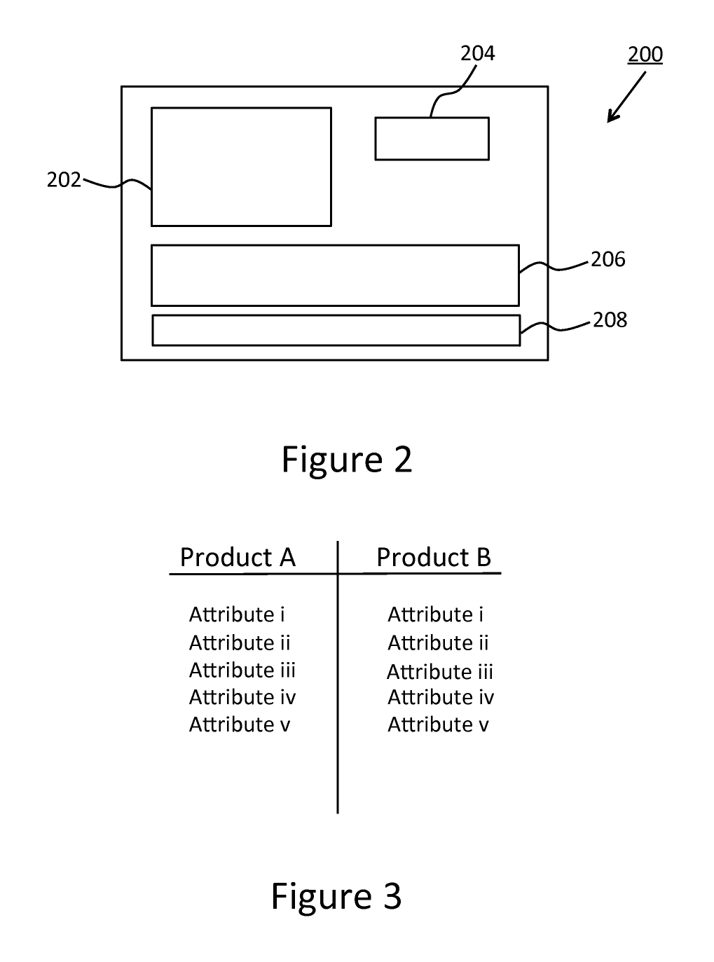

Referring now to FIG. 2, shown is a simplified diagram of a competitor's product page 200 for a product. The product page 200 contains information relating to the product, such as for instance a photograph or another visual representation 202 of the product, the price 204 of the product, a description 206 of the product including an indication of features or attributes of the product, and optionally other information 208 relating to delivery terms, offer conditions, other limitations etc. A robot module, such as for instance a WebCrawler or spider, of the data processing system 122 extracts the data 202-208 from the product page 200. Referring now to FIG. 3, shown is a simplified comparison of the attributes or features of a product that is offered by the subject retailer 102 compared to the features that are believed to be present in the product that is represented by the product page 200, based on the data 202-208 extracted from the product page 200. In this example, the product that is offered by the subject retailer 202 has attributes i-v. Based on the data 202-208 extracted from the product page 200, the competitor's product is believed to have attributes i-v as well, although some of the attributes may be brand-equivalent attributes that are described using different proprietary terminology. The data processing system 122 of the pricing intelligence provider 106 implements product matching rules with parameters that are adjustable by product. Based on the implemented product matching rules and the attributes for the subject retailer's product and the competitor's product, a determination is made whether or not a match exists. For instance, a match is determined to exist if both products have identical feature sets, regardless of the brands of the products. If even one attribute is determined to be different, then no match is determined. That said, in some instances the data relating to a feature may be non-retrievable and the AI process attempts to account for this lack of data and probabilistically determine if both products have identical feature sets.

When it is determined that a match occurs, either probabilistically or otherwise, then a data output linking the product and the non-identically identified product is generated automatically. The data output is for being accessed by a price comparison process, which is in execution on a processor of the pricing intelligence provider 106. Optionally, the pricing intelligence provider generates the data output for being accessed by a price comparison process that is in execution on another processor, such as for instance a processor of the subject retailer 102.

The ability to automatically determine an exact match between a product and a non-identically identified product supports a number of enhanced functions, such as for instance i) determining price adjustments to be competitive with identically featured products of different brands that are offered by a competitor, ii) monitoring a competitor's e-commerce site for minimum advertised pricing (MAP) violations, iii) assessing the assignment of products to a specific taxonomy, iv) monitoring assortment selection, etc.

Determining matches between a product and a non-identically identified product facilitates determining price adjustments. It may be the case that the subject retailer is competitively priced relative to the price that other retailers are charging for the same product of the same brand. Unfortunately, if a competitor is offering at a better price point an identical product that differs only by brand, then the subject retailer may suffer poor sales. By ensuring price competitiveness with non-identically identified products of different brands, in addition to exact matching products of the same brand, the subject retailer is likely to increase both sales and profit. Of course, if it is necessary to reduce the price of the product below a point of being profitable, then the subject retailer may instead discontinue selling the product and instead offer a product that may be priced more competitively with the non-identically identified product.

Of course, products of certain brands are known to command a higher price compared to an otherwise identical product of another brand. Such price differences may be due to the perception that one brand is higher quality than another brand, or one brand simply may be more popular than another brand. The subject retailer may therefore specify a brand premium, or the data processing system may determine a brand premium, in order to modify the results of product matching. In this way, pricing adjustments may be suggested only if it is determined that a competitor is offering a non-identically identified product at a lower price than the subject retailer, taking into account any brand premium. After applying a suggested price adjustment, the price of one of the products may be higher than the price of the other product, but the products are competitively priced once the brand premium is taken into account.

A match between a product and a non-identically identified product indicates that the products are exact matches, and as such determining matches between a product and a non-identically identified product also facilitate the monitoring of minimum advertised price (MAP) violations. For instance, the subject retailer is able to monitor a competitor's advertisements and match non-identically identified products corresponding to products that are offered by the subject retailer. By way of a specific and non-limiting example, products that are advertised on the competitor's website using a description that is different than the manufacturers description for that product may be identified. As such, it becomes more difficult for a competitor to deliberately hide MAP violations simply by providing a product description that is difficult to match with the product that is sold by the subject retailer. Alternatively, MAP violations for house brand products, or even for products that are produced by different manufacturers, may be monitored.

Further, determining matches between non-identically identified products may facilitate assessing the taxonomy to which a product is assigned. For instance, a HDTV offered by the subject retailer may be classified as a consumer electronic product, whilst a competitor's identical but non-identically identified HDTV of a different brand may be classified as a business display product. If the business display product taxonomy would allow the subject retailer to charge a premium price on the price for the same product, then the subject retailer may assign the HDTV to the business display taxonomy.

Further still, determining matches between non-identically identified products may facilitate assortment selection monitoring. For instance, if no matches are determined between a product that is offered for sale by the subject retailer and any of the products that are offered for sale by the competitor, then the subject retailer may identify an opportunity to add a premium to the price of the product. More particularly, since the AI process is capable of determining exact matches between non-identically identified products, the failure to match a product with any of the competitor's products strongly suggest that the competitor does not offer any products with an identical feature set. As such, assortment selection monitoring may be performed in a reliable fashion even if the competitor attempts to obfuscate the identities of its products.

While the above description constitutes a plurality of embodiments of the present invention, it will be appreciated that the present invention is susceptible to further modification and change without departing from the fair meaning of the accompanying claims.

What is claimed is:

1. A computer system-implemented method, comprising:
using a process in execution on a processor of a computer system, accessing product description information and pricing information for a product sold by a first retailer;
accessing using a robot module, via an electronic communication network, product description information and pricing information for a non-identically identified product that is offered for sale by a second retailer;
implementing in a feature analyzer module in execution on the processor of the computer system, product matching rules with parameters that are adjustable by product;
accessing implemented product matching rules for the first retailer that cover the product sold by the first retailer, and responsive to the product description information for the product and for the non-identically identified product and said implemented rules, automatically determining whether or not an exact feature match exists between the product and the non-identically identified product; and
upon determining an exact feature match, automatically generating a data output linking the product and the non-identically identified product, the data output for being accessed by a price comparison process.

2. The computer system-implemented method of claim 1 wherein determining whether or not an exact feature match exists between the product and the non-identically identified product is other than based on a number of search result hits returned for the non-identically identified product.

3. The computer system-implemented method of claim 1 wherein the non-identically identified product is other than a product that is sponsored for being linked with the product sold by the first retailer.

4. The computer system-implemented method of claim 1 wherein determining whether or not an exact feature match exists between the product and the non-identically identified product is performed using an artificial intelligence (AI) process that is in execution on the processor of the computer system.

5. The computer system-implemented method of claim 1 comprising, using the price comparison process, accessing the data output and automatically comparing the pricing information of the product to the pricing information of the non-identically identified product.

6. The computer system-implemented method of claim 5 comprising automatically generating a human-intelligible report including the pricing information of the product compared to the pricing information of the non-identically identified product.

7. The computer system-implemented method of claim 5 comprising, based on a result of comparing the pricing information of the non-identically identified product to the minimum advertised price of the product, determining a violation of the minimum advertised price, and wherein the human-intelligible report includes an indication of the violation.

8. The computer system-implemented method of claim 7 comprising automatically capturing an image including the pricing information of the non-identically identified product that is in violation of the minimum advertised price of the product.

9. The computer system-implemented method of claim 1 wherein the brand of the product is different than the brand of the non-identically identified product.

10. The computer system-implemented method of claim 1 wherein the product and the non-identically identified product are each classified according to different business taxonomy.

11. The computer system-implemented method of claim 1 wherein the step of accessing product description information and pricing information for the product sold by the first retailer comprises retrieving said product description information and pricing information from a database that is maintained for the first retailer.

12. The computer system-implemented method of claim 1 wherein the step of accessing product description information and pricing information for the product sold by the first retailer comprises extracting said product description information and pricing information from a product page for the product on an e-commerce site of the first retailer.

13. The computer system-implemented method of claim 1 wherein the step of accessing product description information and pricing information for the non-identically identified product that is offered for sale by the second retailer comprises extracting data from a product page for the non-identically identified product on an e-commerce site of the second retailer.

14. The computer system-implemented method of claim 1 wherein the step of accessing product description information and pricing information for the non-identically identified product that is offered for sale by the second retailer comprises retrieving data for the non-exact matching product from a database that is maintained for the different retailer.

15. The computer system-implemented method of claim 1 comprising building a searchable product index, the searchable product index comprising a plurality of product identifiers, and there being associated with each product identifier an indication of at least one location of product description information and pricing information relating to a product that is identified by said associated product identifier.

16. The computer system-implemented method of claim 15 wherein the searchable product index comprises an index linking features to product identifiers such that the products are searchable based on the extracted feature content.

17. A computer system-implemented method, comprising:
using a process in execution on a processor of a computer system, accessing product description information and pricing information for a product sold by a first retailer;
accessing using a robot module, via an electronic communication network, product description information and pricing information for a non-identically identified product that is offered for sale by a second retailer;
establishing a set of rules for determining an exact feature match to the product sold by the first retailer;
implementing in a feature analyzer module, in execution on the processor of the computer system, the established set of rules;
accessing the implemented set of rules, and responsive to the product description information for the product and for the non-identically identified product and said implemented rules, automatically determining whether or not an exact feature match exists between the product and the non-identically identified product; and
upon determining an exact feature match, automatically generating a data output linking the product and the non-identically identified product, the data output for being accessed by a price comparison process.

18. The computer system-implemented method of claim 17 comprising using the price comparison process, accessing the data output and generating a human-intelligible report including the price of the product compared to the price of the non-identically identified product.

19. A data processing system, comprising:
a module executing on a processor and accessing available product description information and pricing information for a product sold by a first retailer;
a robot module executing on a processor and accessing, via an electronic communication network, product description information and pricing information for a non-identically identified product that is offered for sale by a second retailer;
a module executing on a processor implementing product matching rules with parameters that are adjustable by product;
a module executing on a processor accessing the implemented product matching rules for the first retailer that cover the product sold by the first retailer, and responsive to the product description information for the product and for the non-identically identified product and said implemented rules, automatically determining whether or not an exact feature match exists between the product and the non-identically identified product; and
a module executing on a processor and responsive to a determination that an exact feature match exists between the product and the non-identically identified product, automatically generating a data output linking the product and the non-identically identified product, the data output for being accessed by a price comparison process.

20. The data processing system of claim 19 comprising a module executing on a processor and responsive to the data output generating a human-intelligible report including the price of the product compared to the price of the non-identically identified product.
